(19) United States
(12) Patent Application Publication
(10) Pub. No.: US 2026/0229701 A1
(43) Pub. Date: Aug. 6, 2026

(54) SOLID-STATE BATTERY AND MANUFACTURING METHOD OF THE SOLID-STATE BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi (JP)

(21) Appl. No.: 19/339,919

(22) Filed: Sep. 25, 2025

(30) Foreign Application Priority Data
Feb. 3, 2025 (JP) 2025-016407

(51) Int. Cl. H01M 50/426; H01M 4/38; H01M 4/62; H01M 10/0562; H01M 10/058; H01M 50/449

(52) U.S. Cl. CPC H01M 50/426; H01M 4/386; H01M 4/623; H01M 10/0562; H01M 10/058; H01M 50/449

(57) ABSTRACT

A solid-state battery according to the present disclosure includes a cathode layer, an anode layer, and a solid electrolyte layer disposed between the cathode layer and the anode layer. The solid electrolyte layer includes a solid electrolyte, a first binder, and a second binder. A softening temperature of the first binder is higher than that of the second binder. Content of the first binder in the solid electrolyte layer is 0.5% by volume to 4.0% by volume, and also content of the second binder in the solid electrolyte layer is 2.5% by volume to 12.5% by volume. The laminated electrode body in which the solid electrolyte layer is disposed between the cathode layer and the anode layer is densified by pressing the laminated electrode body at a temperature equal to or higher than the softening temperature of the second binder and lower than the softening temperature of the first binder.

### CROSS-REFERENCE TO RELATED APPLICATION

This application claims priority to Japanese Patent Application No. 2025-016407 filed on Feb. 3, 2025. The disclosure of the above-identified application, including the specification, drawings, and claims, is incorporated by reference herein in its entirety.

### BACKGROUND

### 1. Technical Field

The present disclosure relates to a solid-state battery and a manufacturing method of the solid-state battery.

### 2. Description of Related Art

Solid-state batteries using solid electrolytes have been proposed as lithium ion secondary batteries with excellent safety, and an all-solid-state battery having a solid electrolyte layer is known as one example.

Japanese Unexamined Patent Application Publication No. 2021-86720 (JP 2021-86720 A) discloses an all-solid-state battery in which a solid electrolyte layer includes a first solid electrolyte and a second solid electrolyte. Japanese Unexamined Patent Application Publication No. 2015-069843 (JP 2015-069843 A) discloses a method for manufacturing an all-solid-state battery having a laminate configured in a manner such that a solid electrolyte layer made of a solid electrolyte is sandwiched between a cathode layer containing a cathode active material and an anode layer containing an anode active material. It is disclosed that decomposition temperature of the binder that is mixed in the cathode layer and the anode layer is higher than the decomposition temperature of the binder that is mixed in the solid electrolyte layer.

### SUMMARY

In solid-state batteries, there is a concern of short-circuiting occurring due to cracking of the solid electrolyte layer or the like, caused by contamination by foreign matter during the manufacturing process or expansion of electrodes during charging.

The present disclosure has been made in view of the above circumstances.

A problem to be solved by one embodiment of the present disclosure is to provide a solid-state battery that is less susceptible to short-circuiting caused by contamination by foreign matter during manufacturing, or by electrode expansion during charging.

A problem to be solved by another embodiment of the present disclosure is to provide a method for manufacturing a solid-state battery that is less susceptible to short-circuiting caused by contamination by foreign matter during manufacturing, or by electrode expansion during charging.

Measures for solving the above problems include the following aspects.

<1> A solid-state battery including a cathode layer, an anode layer, and a solid electrolyte layer that is disposed between the cathode layer and the anode layer, in which the solid electrolyte layer includes a solid electrolyte, a first binder, and a second binder, a softening temperature of the first binder is higher than a softening temperature of the second binder, and content of the first binder in the solid electrolyte layer is 0.5% by volume to 4.0% by volume, and also content of the second binder in the solid electrolyte layer is 2.5% by volume to 12.5% by volume.

<2> The solid-state battery according to <1>, in which at least one of the cathode layer and the anode layer contains a third binder, and a softening temperature of the third binder is higher than the softening temperature of the second binder.

<3> The solid-state battery according to <1> or <2>, in which the softening temperature of the first binder is higher than the softening temperature of the second binder by 50° C. or more.

<4> The solid-state battery according to any one of <1> to <3>, in which the anode layer contains a Si-based anode active material.

<5> A manufacturing method of a solid-state battery includes fashioning a laminated electrode body including a cathode layer, an anode layer, and a solid electrolyte layer that is disposed between the cathode layer and the anode layer, in which the solid electrolyte layer includes a solid electrolyte, a first binder, and a second binder, a softening temperature of the first binder is higher than a softening temperature of the second binder, and content of the first binder in the solid electrolyte layer is 0.5% by volume to 4.0% by volume, and also content of the second binder in the solid electrolyte layer is 2.5% by volume to 12.5% by volume, and densifying the laminated electrode body by pressing at a temperature equal to or higher than the softening temperature of the second binder and lower than the softening temperature of the first binder.

According to one embodiment of the present disclosure, there is provided a solid-state battery that is less susceptible to short-circuiting caused by contamination by foreign matter during manufacturing, or by electrode expansion during charging.

According to another embodiment of the present disclosure, there is provided a method for manufacturing a solid-state battery that is less susceptible to short-circuiting caused by contamination by foreign matter during manufacturing, or by electrode expansion during charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a laminate structure of a solid-state battery according to the present disclosure.

### DETAILED DESCRIPTION OF EMBODIMENTS

In the present disclosure, numerical value ranges that are indicated using “to” indicate a range that includes numerical values that are described before and after the “to” as the minimum value and the maximum value, respectively.

In the present disclosure, in which numerical value ranges are described in stages, an upper limit value or a lower limit value that is described in a certain numerical value range may be replaced with an upper limit value or a lower limit value of another numerical value range that is described in stages. In the numerical value ranges that are described in the present disclosure, an upper limit value or a lower limit value that is described in a certain numerical value range may be replaced with a value that is indicated in the Examples.

In the present disclosure, a combination of two or more preferred forms is a more preferred form.

In the present disclosure, when there is a plurality of types of substances corresponding to each component, the amount of each component means the total amount of the substances of the multiple types, unless otherwise specified.

In the present disclosure, the term “process” refers not only to an independent process but also includes a process that may not be clearly distinguishable from another process, as long as the intended purpose of the process is achieved.

Solid-state batteries include semi-solid batteries having a gel layer containing an electrolytic solution and a polymer between an electrode and a solid electrolyte or the like, and all-solid-state batteries having a layer of a solid electrolyte, with all-solid-state batteries being preferred.

### (1) Solid-State Battery

A solid-state battery according to the present disclosure includes a cathode layer, an anode layer, and a solid electrolyte layer that is disposed between the cathode layer and the anode layer. The solid electrolyte layer contains a solid electrolyte, a first binder, and a second binder. A softening temperature of the first binder is higher than a softening temperature of the second binder. In the solid electrolyte layer, the first binder is contained in an amount of 0.5% by volume to 4.0% by volume, with respect to the solid electrolyte layer. The second binder is contained in an amount of 2.5% by volume to 12.5% by volume with respect to the solid electrolyte layer.

The solid-state battery according to the present disclosure has the above-described configuration, and accordingly the second binder contained in an appropriate amount in the solid electrolyte layer softens and becomes fluidized, when densifying the laminated electrode body including the anode layer, the solid electrolyte layer, and the cathode layer, by a roll press or the like (battery pressing) in manufacturing of the solid-state battery, or under heat during charging. The softened and fluidized second binder of the solid electrolyte layer fills cracks in the solid electrolyte layer, the anode layer and/or the cathode layer, thereby maintaining insulation. Accordingly, it is believed that battery resistance of the solid-state battery is suppressed, while short-circuiting caused by contamination by foreign matter during manufacturing, or electrode expansion during charging, are less likely to occur.

Note that it is sufficient for the solid electrolyte layer to contain each of the first binder and the second binder within the above ranges as the binder, and three or more types of binders may be contained. Note, however, that as the content of the binder in the solid electrolyte layer increases, the strength improves but the electrical resistance also increases. Accordingly, the total amount of the binder in the solid electrolyte layer is preferably less than 16.0% by volume, 15.0% by volume or less, 14.0% by volume or less, or 13.0% by volume or less. Also, from the perspective of the strength as a separator, the total amount of the binder in the solid electrolyte layer is preferably more than 3.0% by volume, 4.0% by volume or more, 5.0% by volume or more, or 6.0% by volume or more.

When a set of a cathode layer, a solid electrolyte layer, and an anode layer is defined as a power generating unit, the solid-state battery may have just one power generating unit or may have two or more power generating units. When the solid-state battery has two or more power generating units, these power generating units may be connected in series or may be connected in parallel. A configuration of the solid-state battery according to the present disclosure will be described in detail below, by way of an example of an all-solid-state battery.

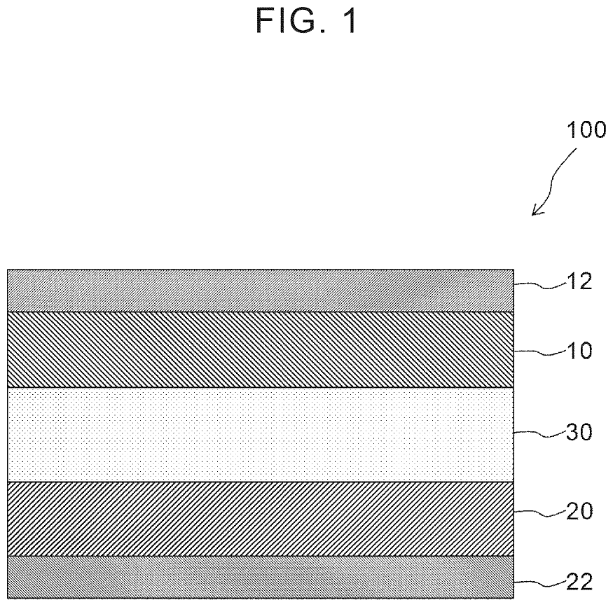

FIG. 1 is a schematic diagram illustrating an example of a laminate structure in an all-solid-state battery. In FIG. 1, the all-solid-state battery 100 includes an anode current collector 12, an anode active material layer (anode layer) 10, a solid electrolyte layer 30, a cathode active material layer (cathode layer) 20, and a cathode current collector 22. The solid electrolyte layer 30 contains a solid electrolyte, a first binder, and a second binder. The anode active material layer 10 contains an anode active material, a conductive material, and a binder. The cathode active material layer 20 contains a cathode active material, a conductive material, and a binder. The all-solid-state battery 100 may include, for example, an outer encasement (omitted from illustration) described below.

### (1.1) Solid Electrolyte Layer

The solid electrolyte layer includes the solid electrolyte, the first binder, and the second binder that has a lower softening temperature than that of the first binder. The first binder is contained in an amount of 0.5 to 4.0% by volume relative to the solid electrolyte layer, and the second binder is contained in an amount of 2.5 to 12.5% by volume relative to the solid electrolyte layer.

### (1.1.1) Solid Electrolyte

The form of the solid electrolyte is, for example, particulate. The particle size of the solid electrolyte is preferably 3.0 μm or less. When the particle size of the solid electrolyte is 3.0 μm or less, the battery resistance of the solid-state battery can be reduced more as compared to when the particle size of the solid electrolyte exceeds 3.0 μm. The particle size of the solid electrolyte is preferably 0.2 μm to 3.0 μm. The method for measuring the particle size of the solid electrolyte is the same as that described in the Examples.

Examples of the solid electrolyte include a sulfide solid electrolyte, an oxide solid electrolyte, a hydride solid electrolyte, a halide solid electrolyte, a nitride solid electrolyte, and so forth. The solid electrolyte may be used as one type alone, or may be used as a combination of two or more types.

The sulfide solid electrolyte preferably contains S as a main component of anionic elements. The sulfide solid electrolyte preferably contains Li, an element A, and S, for example. The element A is at least one type of P, As, Sb, Si, Ge, Sn, B, Al, Ga, and In. The sulfide solid electrolyte may further contain at least one of O and a halogen element. Examples of halogen elements (X) include F, Cl, Br, I, and so forth. From the perspective of excellent chemical stability, the sulfide solid electrolyte preferably has an anionic structure of an ortho composition, as a main component of the anionic structure. Examples of the anionic structure of the ortho composition include a PS₄³⁻ structure, a SiS₄⁴⁻ structure, a GeS₄⁴⁻ structure, an AlS₃³⁻ structure, and a BS₃³⁻ structure. Examples of the composition of the sulfide solid electrolyte include xLi₂S·(100-x)P₂S₅ (70≤x≤80) and yLiI·zLiBr·(100-y-z)(xLi₂S·(1-x)P₂S₅) (0.7≤x≤0.8, 0≤y≤30, 0≤z≤30).

The sulfide solid electrolyte may have a composition that is represented by General Formula (1): Li₄₋ₓGe₁₋ₓPₓS₄ (0<x<1). In the General Formula (1), at least part of Ge may be substituted with at least one of Sb, Si, Sn, B, Al, Ga, In, Ti, Zr, V, and Nb. In the General Formula (1), at least part of P may be substituted with at least one of Sb, Si, Sn, B, Al, Ga, In, Ti, Zr, V, and Nb. In the General Formula (1), part of Li may be substituted with at least one of Na, K, Mg, Ca, and Zn. In the General Formula (1), part of S may be substituted with a halogen. The halogen is at least one of F, Cl, Br and L Other examples of the composition of the sulfide solid electrolyte include Li₇₋ₓ₋₂ZPS_{6-x-y}X_{y}, Li_{8-x-2y}SiS_{6-x-y}X_{y}, Li_{8-z-2y}GeS_{6-x-y}X_{y}, and so forth. X is at least one of F, Cl, Br and I, and x and y are 0≤x, 0≤y.

The oxide solid electrolyte contains, for example, Li, a Z element (Z is at least one of Nb, B, Al, Si, P, Ti, Zr, Mo, W, and S), and O. Examples of oxide solid electrolytes include garnet-type solid electrolytes, perovskite-type solid electrolytes, NASICON-type solid electrolytes, Li—P—O solid electrolytes, Li—B—O solid electrolytes, and so forth.

The hydride solid electrolyte contains, for example, Li and a complex anion containing hydrogen. Examples of the complex anion include (BH₄)⁻, (NH₂)⁻, (AlH₄)⁻, (AlH₆)³⁻, and so forth.

The halogenated solid electrolyte may be Li₆3zZ_{z}X₆ (X is at least one of Cl and Br, and z is 0<z<2).

Examples of the nitride solid electrolyte include Li₃N and so forth.

In particular, the solid electrolyte preferably contains a sulfide solid electrolyte, and more preferably is made of a sulfide solid electrolyte. When the solid electrolyte contains a sulfide solid electrolyte, the battery resistance of the solid-state battery is further reduced.

### (1.1.2) Binder

The solid electrolyte layer includes the first binder and the second binder having different softening temperatures. The first binder has a softening temperature that is higher than the softening temperature of the second binder. The softening temperature of the binder is a glass transition temperature that is determined from a differential scanning calorimetry (DSC) curve that is obtained by DSC.

Examples of binders that can be contained in the solid electrolyte layer include rubber-based binders, fluoride-based binders, and so forth. Examples of rubber-based binders include butadiene rubber, hydrogenated butadiene rubber, styrene butadiene rubber (SBR), hydrogenated styrene butadiene rubber, nitrile butadiene rubber, hydrogenated nitrile butadiene rubber, ethylene propylene rubber, and so forth. Examples of fluoride-based binders include polyvinylidene fluoride (PVDF), polyvinylidene fluoride-hexafluoropropylene copolymer (PVDF-HFP), polytetrafluoroethylene, fluororubber, and so forth.

The softening temperature of the first binder is preferably higher than the softening temperature of the second binder by 50° C. or more. For example, a PVDF (polyvinylidene fluoride, softening temperature 170° C.) based binder can be used as the first binder, and an SBR (styrene-butadiene rubber, softening temperature 120° C.) based binder can be used as the second binder.

In the solid electrolyte layer, the first binder is contained in an amount of 0.5 to 4.0% by volume and the second binder is contained in an amount of 2.5 to 12.5% by volume. When the solid electrolyte layer contains each of the first binder and the second binder within the above ranges, short-circuiting is effectively suppressed. Furthermore, in addition to functioning as a separator, increase in ion migration resistance (electrical resistance) can be suppressed.

The content of the first binder in the solid electrolyte layer may be 1.0% by volume or more and 3.5% by volume or less with respect to the solid electrolyte layer. The content of the second binder in the solid electrolyte layer may be 3.0% by volume or more, 4.0% by volume or more, or 5.0% by volume or more, with respect to the solid electrolyte layer. The content of the second binder in the solid electrolyte layer may be 12.0% by volume or less, 11.0% by volume or less, or 10.0% by volume or less, with respect to the solid electrolyte layer.

The thickness of the solid electrolyte layer is preferably 50 μm or less, and more preferably 20 μm or less, from the perspective of further reducing the battery resistance of the solid-state battery, and so forth. The thickness of the solid electrolyte layer is preferably 1 μm to 50 μm. Note that the thinner the solid electrolyte layer is, the more readily short-circuiting will occur due to cracks during manufacturing and so forth, however, even when the solid electrolyte layer has a thickness of 20 μm or less, for example, short-circuiting occurs less readily when the solid electrolyte layer contains appropriate amounts of the first binder and the second binder.

### (1.2) Cathode Layer

The cathode layer contains a cathode active material. The cathode layer may contain at least one of a solid electrolyte, a conductive material, and a binder, as necessary. As for the cathode active material, examples of the oxide active material include layered rock-salt active materials, spinel type active materials, olivine type active materials, and so forth.

A protective layer may be formed on a surface of the oxide active material. The protective layer preferably contains a Li-ion conductive oxide (e.g., LiNbO₃). The protective layer can suppress reaction between the oxide active material and the solid electrolyte. The thickness is, for example, 1 nm to 30 nm.

The form of the cathode active material is, for example, particulate. The particle size of the cathode active material is preferably 10 nm to 50 μm. The method for measuring the particle size is the same as that described in the Examples.

The cathode layer may contain a conductive material. Examples of the conductive material include carbon materials, metal particles, conductive polymers, and the like.

The solid electrolyte and the binder that is used in the cathode layer can be the same as those that are exemplified as a solid electrolyte and a binder that can be contained in a solid electrolyte sheet. When the cathode layer contains a binder, for example, when the binder in the cathode layer is softened during densification when manufacturing, the conductive material contained in the cathode layer may penetrate into the solid electrolyte layer, causing electrical conduction. Accordingly, the softening temperature of the binder (third binder) that is contained in the cathode layer is preferably higher than the softening temperature of the second binder that is contained in the solid electrolyte layer. For example, the same binder can be used for the first binder that is contained in the solid electrolyte layer and the third binder that is contained in the cathode layer.

The thickness of the cathode layer is not limited in particular, but preferably is 0.1 μm to 1000 μm.

### (1.3) Cathode Current Collector

The solid-state battery may include a cathode current collector. The cathode current collector is disposed on the opposite side of the cathode layer from the solid electrolyte layer. Examples of materials for the cathode current collector include stainless steel, aluminum, nickel, iron, titanium, carbon, and so forth. The cathode current collector may be in the form of a foil or a mesh, for example.

### (1.4) Anode Layer

The anode layer contains an anode active material. The anode layer may contain at least one of a solid electrolyte, a conductive material, and a binder, as necessary.

Examples of the anode active material include a Li-based active material, a carbon-based active material, an oxide-based active material, and a Si-based active material. Examples of the Si-based active material include elemental Si, Si alloys, silicon oxide, and so forth. The Si-based active material expands and contracts greatly during charging and discharging, cracks readily occur in the anode layer, but by including appropriate amounts of each of the first binder and the second binder in the solid electrolyte layer, the second binder softens and fluidizes due to heat during manufacturing and during charging and discharging, facilitating obtaining mending effects.

The form of the anode active material is, for example, particulate. The particle size of the anode active material is preferably 10 nm to 50 μm. The method for measuring the particle size is the same as that described in the Examples.

The conductive material, the solid electrolyte, and the binder that are used in the anode layer may be the same as those that are exemplified as the conductive material, the solid electrolyte, and the binder that can be included in the cathode layer. When the anode layer contains a binder, the softening temperature of the binder (third binder) that is contained in the anode layer is preferably higher than the softening temperature of the second binder that is contained in the solid electrolyte layer, for the same reasons as with the binder that can be contained in the cathode layer. For example, the same binder can be used for the first binder that is contained in the solid electrolyte layer and the third binder that is contained in the anode layer. Note that when the cathode layer and the anode layer each contain a binder, the binder that is contained in the cathode layer and the binder that is contained in the anode layer may be the same binder (same type) or may be different binders (different types).

The thickness of the anode layer is not limited in particular, but is preferably 0.1 μm to 1000 μm.

### (1.5) Anode Current Collector

The solid-state battery may include an anode current collector. Examples of materials for the anode current collector include stainless steel, copper, nickel, carbon, and so forth. The anode current collector may be in the form of a foil or a mesh, for example.

### (1.6) Outer Encasement

The solid-state battery may include an outer encasement. The outer encasement accommodates at least the power generating unit that is described above. Examples of the outer encasement include a laminate-type outer encasement, a case-type outer encasement, and so forth.

### (1.7) Constraining Member

The solid-state battery may include a constraining member. The constraining member applies constraining pressure to the cathode layer, the solid electrolyte layer, and the anode layer, in a thickness direction. The constraining pressure is preferably 0.1 MPa to 100 MPa.

### (1.8) Usage

Solid-state batteries are used as power sources for vehicles, electronic devices, electrical storage, and so forth. In particular, the solid-state battery according to the present disclosure is preferably used as a drive power source for a hybrid electric vehicle (HEV), a plug-in hybrid electric vehicle (PHEV), or a battery electric vehicle (BEV).

### (2) Manufacturing Method of Solid-State Battery

A manufacturing method of a solid-state battery according to the present disclosure includes forming a laminated electrode body (laminated electrode body forming process) and pressing the laminated electrode body for densification thereof (pressing process).

### (2.1) Laminated Electrode Body Forming Process

In the laminated electrode body forming process, the laminated electrode body including the cathode layer, the anode layer, and the solid electrolyte layer that is disposed between the cathode layer and the anode layer, is formed. The solid electrolyte layer includes the solid electrolyte, the first binder, and the second binder. The softening temperature of the first binder is higher than the softening temperature of the second binder, the content of the first binder in the solid electrolyte layer is 0.5 to 4.0% by volume, and also the content of the second binder is 2.5 to 12.5% by volume.

The solid electrolyte, the first binder, and the second binder, which are contained in the solid electrolyte layer, are each as described above. The materials making up the cathode layer and the anode layer are also as described above.

### (2.2) Pressing Process

In the pressing process, the laminated electrode body is pressed and densified at a temperature that is equal to or higher than the softening temperature of the second binder and that is lower than the softening temperature of the first binder. The laminated electrode body in which the cathode layer, the solid electrolyte layer, and the anode layer, are laminated in this order, can be densified by roll pressing. The laminated electrode body is pressed to be densified (battery pressing) at a set temperature within a range of, for example, the softening temperature of the second binder +10° C., to the softening temperature of the first binder −10° C. Thus, only the second binder, out of the first binder and the second binder that are contained in the solid electrolyte layer, is softened and fluidized during pressing, and cracks in the solid electrolyte layer, the cathode layer, and/or the anode layer are mended. Also, the solid-state battery that is manufactured is less susceptible to short-circuiting caused by electrode expansion during charging.

The present disclosure will be described in further detail below with reference to Examples, but the disclosure according to the present disclosure is not limited to these Examples.

### [1] Measurement Method

### Particle Size

The particle sizes of the sulfide solid electrolyte, the cathode active material, and the anode active material, were measured using a laser diffraction particle size distribution analyzer. Specifically, the substance to be measured was dispersed in a dispersion medium and the volumetric particle size distribution was measured using a particle size distribution analyzer, and a particle size (D50) corresponding to 50% of the volumetric integrated particle size distribution values obtained was defined as the particle size.

### Specific Surface Area

The specific surface areas of the cathode active material, the anode active material, the cathode conductive material, and the anode conductive material, were measured by the Brunauer-Emmett-Teller (BET) method (JIS R1626-1996). Vol % means “% by volume”.

### Example 1

### Preparation of Solid Electrolyte Sheet

A glass ceramic (specific gravity 2.0) having an average particle size (D50) of 1 μm and a composition of 15LiBr·10LiI·75 (0.75Li₂S·0.25P₂S₅) was used as a sulfide solid electrolyte. With respect to 100 parts by mass of the sulfide solid electrolyte, 1 part by mass of a PVDF-based binder (polyvinylidene fluoride, softening temperature 170° C., specific gravity 1.8), and 3 parts by mass of an SBR-based binder (styrene-butadiene rubber, softening temperature 120° C., specific gravity 0.9), were weighed out. These were mixed with butyl butyrate to a solid content of 50% by mass, and subjected to ultrasonic dispersion treatment for 1 minute using an ultrasonic dispersion device, so as to obtain a solid electrolyte paste. The solid electrolyte paste that was obtained was uniformly applied onto an aluminum foil having a thickness of 15 μm, by blade coating using a commercially-available applicator, to achieve a coating weight of 3.0 mg/cm². The coating was dried at 100° C. for 60 minutes to obtain a solid electrolyte sheet on the aluminum foil.

### Preparation of Cathode Sheet

As for the cathode active material, LiNi_{1/3}Mn_{1/3}Co_{1/3}O₂ powder with an average particle size (D50) of 10 μm and a specific surface area of 1 m²/g was used. The surface of this cathode active material was coated with LiNbO₃ using the sol-gel process. As for the solid electrolyte, the same sulfide solid electrolyte as that used in the solid electrolyte sheet was used. With respect to 100 parts by mass of the cathode active material, 20 parts by mass of the sulfide solid electrolyte, 10 parts by mass of the conductive material (CNF, specific surface area 14 m²/g), and 1 part by mass of the same PVDF-based binder as that of the solid electrolyte layer, were weighed out. These were mixed with butyl butyrate to a solid content of 60% by mass, and subjected to ultrasonic dispersion treatment for 1 minute using an ultrasonic dispersion device to obtain a composition for forming a cathode active material layer (cathode paste). The cathode paste thus obtained was uniformly applied onto a cathode current collector that was made of an aluminum foil with a thickness of 15 μm by blade coating using a commercially-available applicator to achieve a coating weight of 33 mg/cm². Thereafter, the coating film was dried at 100° C. for 60 minutes to obtain a cathode sheet in which a cathode layer was formed on the aluminum foil.

### Preparation of Anode Sheet

As for the anode active material, Si powder having an average particle size (D50) of 3 μm and a specific surface area of 4 m²/g was used, and for the sulfide solid electrolyte, the same sulfide solid electrolyte as that of the solid electrolyte sheet was used. With respect to 100 parts by mass of the anode active material, 50 parts by mass of the sulfide solid electrolyte, 10 parts by mass of the same conductive material as in the cathode layer (CNF, specific surface area 14 m²/g), and 5 parts by mass of the same PVDF-based binder as in the solid electrolyte sheet, were weighed out. These were mixed with butyl butyrate to a solid content of 40% by mass, and subjected to ultrasonic dispersion treatment for 1 minute using an ultrasonic dispersion device to obtain a composition for forming an anode active material layer (anode paste). The anode paste that was obtained was uniformly applied onto a surface-roughened copper foil having a thickness of 20 μm by blade coating using a commercially-available applicator to achieve a coating weight of 7.5 mg/cm². Thereafter, the coating film was dried at 100° C. for 60 minutes to obtain an anode sheet in which an anode layer was formed on the surface-roughened copper foil.

### Fabrication of All-Solid-State Battery

The anode layer was cut along with the copper foil into a 1.2 cm×1.2 cm square, a solid electrolyte sheet cut to the same shape was placed on top thereof, and the solid electrolyte layer was transferred to the anode by roll pressing at room temperature under a pressure of 1 ton/cm. The aluminum foil that had been attached to the solid electrolyte layer that was transferred to the anode was peeled off. The cathode along with the aluminum foil was cut into a 1.0 cm×1.0 cm square, which was then placed on the solid electrolyte layer that was transferred to the anode such that the cathode layer and the solid electrolyte layer faced each other, following which the cathode was transferred onto the solid electrolyte layer by roll pressing at room temperature under a press pressure of 2 ton/cm, thereby fabricating a laminated electrode body of anode/solid electrolyte layer/cathode. The laminated electrode body that was obtained was roll-pressed at 150° C. and 4 ton/cm to densify the electrode body. The laminated electrode body that was densified was sealed in an outer encasement made of an aluminum laminate film to which positive and anode terminals were attached, to fabricate a test all-solid-state battery (all-solid-state lithium ion secondary battery) according to Example 1.

### Examples 2 to 5 and Comparative Examples 1 to 4

Test all-solid-state batteries were fabricated in the same manner as in Example 1, except that the compound ratio (mixing ratio, Vol %) of the solid electrolyte layer was changed as shown in Table 1.

### Evaluation

### Self-Discharge Test

The battery was constrained at 1 MPa and charged at a current value of 2 mA with an upper limit voltage of 4.5 V by CCCV charging, and the voltage change was measured after resting for 24 hours to 48 hours.

### Cell Resistance Measurement

The battery (cell) was discharged at a current value of 2 mA to a lower limit voltage of 2.5 V by CCCV discharging, then charged at an upper limit voltage of 3.5 V by CCCV charging, and discharged by CC discharging at a current value of 10 mA for 10 s, and the cell resistance was calculated according to Ohm's law. “CC” stands for constant-current method. “CV” stands for constant-voltage method. “CCCV” stands for constant-current-constant-voltage method.

### Durability Test

The battery was subjected to 100 cycles of charging at an upper limit voltage of 3.5 V by CCCV charging and discharging at a lower limit voltage of 2.5 V by CCCV discharging at a current value of 4 mA, and then the self-discharge test was carried out again.

The results are shown in Table 1. The cell resistance is shown as a ratio as to the cell resistance of Comparative Example 1.

TABLE 1

| | | Example | Example | Example | Example | Comparative | Comparative | Comparative | Comparative |
|---|---|---|---|---|---|---|---|---|---|
| | | 1 | 2 | 3 | 4 | Example 1 | Example 2 | Example 3 | Example 4 |
| | | Vol % | Vol % | Vol % | Vol % | Vol % | Vol % | Vol % | Vol % |
| Material | Solid | 89.0 | 94.0 | 87.0 | 92.0 | 97.0 | 90.0 | 97.0 | 84.0 |
| mixing | Electrolyte | | | | | | | | |
| ratio | PVDF | 1.0 | 1.0 | 3.0 | 3.0 | 3.0 | 0.0 | 1.0 | 1.0 |
| (Vol %) | Binder | | | | | | | | |
| | SBR | 10.0 | 5.0 | 10.0 | 5.0 | 0.0 | 10.0 | 2.0 | 15.0 |
| | Binder | | | | | | | | |

| | | | | | | | | |
|---|---|---|---|---|---|---|---|---|
| Initial | 8 | 5 | 5 | 8 | 8 | 146 | 7 | 9 |
| self-discharge | | | | | | | | |
| [mV] | | | | | | | | |
| Cell resistance | 1.05 | 0.96 | 1.03 | 0.95 | 1.00 | Not | 1.00 | 2.40 |
| [compared to | | | | | | implemented | | |
| Comparative | | | | | | | | |
| Example 1] | | | | | | | | |
| Self-discharge | 5 | 9 | 7 | 6 | 467 | Not | 255 | 7 |
| after durability | | | | | | implemented | | |
| [mV] | | | | | | | | |

The test all-solid-state batteries of Examples 1 to 4, in which the solid electrolyte layer contained an appropriate amount of a binder (SBR) of which the softening temperature was lower than the temperature at which the electrode body was densified, did not exhibit increase in resistance and were able to suppress self-discharge after durability testing, i.e., internal short-circuiting. It is presumed that performing the densification by pressing at a temperature equal to or higher than the softening temperature of the SBR that was contained in the solid electrolyte layer caused the SBR to flow inside the electrode body and fill cracks and voids, thereby improving insulation properties.

Note that in the case of using only SBR (Comparative Example 2), self-discharge occurred in the early stages of charging, and it is presumed that the solid electrolyte layer became too soft during high-temperature densification and was deformed (crushed), to where insulation could no longer be maintained.

What is claimed is:

1. A solid-state battery comprising:
a cathode layer; an anode layer; and a solid electrolyte layer that is disposed between the cathode layer and the anode layer, wherein
the solid electrolyte layer includes a solid electrolyte, a first binder, and a second binder,
a softening temperature of the first binder is higher than a softening temperature of the second binder, and
content of the first binder in the solid electrolyte layer is 0.5% by volume to 4.0% by volume, and also content of the second binder in the solid electrolyte layer is 2.5% by volume to 12.5% by volume.

2. The solid-state battery according to claim 1, wherein at least one of the cathode layer and the anode layer contains a third binder, and a softening temperature of the third binder is higher than the softening temperature of the second binder.

3. The solid-state battery according to claim 1, wherein the softening temperature of the first binder is higher than the softening temperature of the second binder by 50° C. or more.

4. The solid-state battery according to claim 1, wherein the anode layer contains a Si-based anode active material.

5. A manufacturing method of a solid-state battery, the manufacturing method comprising:
fashioning a laminated electrode body including a cathode layer, an anode layer, and a solid electrolyte layer that is disposed between the cathode layer and the anode layer, in which the solid electrolyte layer includes a solid electrolyte, a first binder, and a second binder, a softening temperature of the first binder is higher than a softening temperature of the second binder, and content of the first binder in the solid electrolyte layer is 0.5% by volume to 4.0% by volume, and also content of the second binder in the solid electrolyte layer is 2.5% by volume to 12.5% by volume; and
densifying the laminated electrode body by pressing at a temperature equal to or higher than the softening temperature of the second binder and lower than the softening temperature of the first binder.
